(19) United States
(12) Patent Application Publication
(10) Pub. No.: US 2019/0343101 A1
(43) Pub. Date: Nov. 14, 2019

(54) Tungsten Rattle Head for Fishing

(71) Applicant: Jeffrey Carroll Queen, Catawba, NC (US)

(72) Inventor: Jeffrey Carroll Queen, Calawba, NC (US)

(21) Appl. No.: 15/898,600

(22) Filed: May 11, 2018

(51) Int. Cl. A01K 85/01

(52) U.S. Cl. CPC A01K 85/01

(57) ABSTRACT

A tungsten rattle head used on fishing lures is used to attract and catch more fish. The present invention increases fishing performance by reducing bulk, eliminating protrusions, and reducing impediments while achieving a louder sound chamber. There are no rattling fishing lures that take advantage of placing one or more rattle elements in a tungsten body. Using a hollow chamber in a tungsten body allows one or more rattling elements to be added while keeping the size of the lure head small and more appealing to fish. The rattle elements click or rattle to attract fish to the bait during the cast and retrieve. By placing the rattle inside the head, there are no protrusions or impediments resulting in increased fish catching ability. The tungsten rattle head can be attached to a hook or wire and used in a variety of fishing lures

### BACKGROUND OF INVENTION

The present invention relates to a fishing lure. Specifically, a tungsten rattle head used on a fishing lure. A tungsten body is attached to a wire or hook. A rattle element is placed inside a hollow cavity in the tungsten body. During cast and retrieve, a rattle element will click or rattle to attract fish.

Current rattling fishing lures use materials like lead or brass heads to achieve the weight needed for sinking the lure. The rattling elements are attached to the lure or placed in the lead or brass body. Due to the density of the materials and the rattle elements that are attached to these lures there is undesired bulk, protrusions, and impediments that impact the performance. The present invention increases fishing performance by reducing bulk, eliminating protrusions, and reducing impediments while achieving a louder sound chamber. The higher density of a tungsten body allows for a rattle element inside a smaller size body with no protrusions. The smaller size, with elimination of protrusions and attachments, is not possible with other less dense materials. Placing a rattle element in a tungsten body achieves the following benefits:
1) less body bulk, with no protrusions from rattles, and no rattling attachments enhances fish striking appeal
2) less body bulk, with no protrusions from rattles, and no rattling attachments reduces impediment in the casting of the lure or the hooking of the fish
3) the rattle element makes a louder click or rattle when contacting with the higher density material

It is apparent that many modifications and variations of this invention as herein before set forth may be made without departing from the spirit and scope thereof.

In these respects, the tungsten rattle head according to the present invention substantially departs from the conventional concepts and designs of any prior art. In so doing the tungsten rattle head provides a fishing lure primarily developed for the purpose of attracting and catching more fish by creating an effective click or rattle with less bulk, no protrusions, and no impediments.

### DESCRIPTION OF THE PREFERRED EMBODIMENT

The invention is illustrated by the accompanying drawings in which:

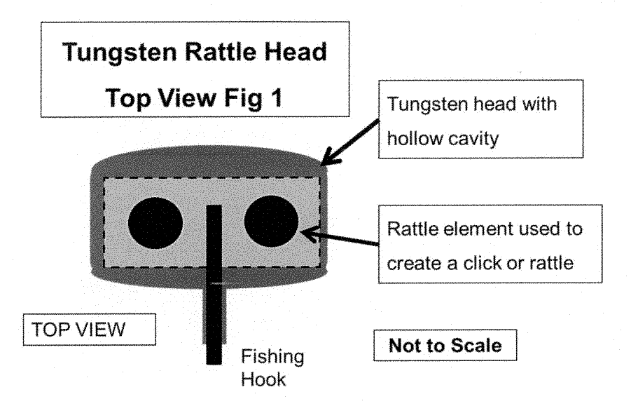

FIG. 1: A top view of a tungsten rattle head for use in fishing which comprises:
a) a tungsten body with a hollow channel constituting a rattle chamber
b) a fish hook or wire secured to the forward most end of said tungsten body, the shank of said fish hook or wire being centrally disposed within said tungsten body
c) at least one noise-making rattle element loosely held within the hollow channel

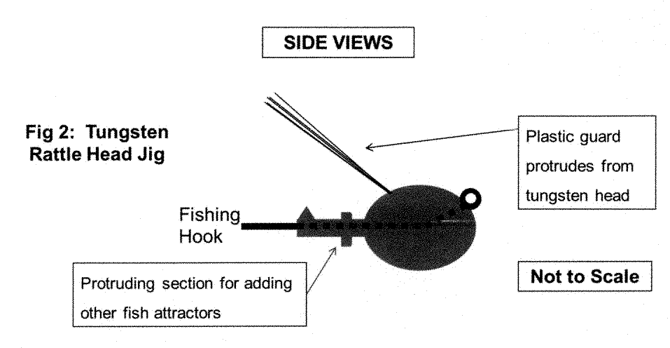

FIGS. 2 through 4 show the tungsten rattle head used in variations of fishing lures to illustrate the spirit and scope of the invention

FIG. 2: A side view of a tungsten rattle head for use in fishing which comprises:
a) A tungsten body with a rattle chamber
b) A hook attached to tungsten body
c) An optional fiber weed guard attached to tungsten body used to prevent snagging of the lure
d) A protrusion from tungsten body used for attaching fish attractors such as plastic body, jig skirt, feathers, synthetic hairs, or similar fishing accessories.
e) an eyelet secured to the rearward end of said body for attaching a fishing line

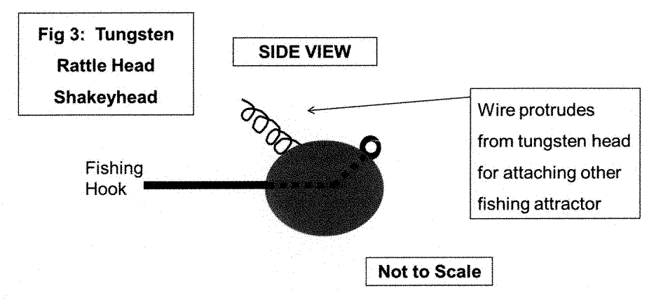

FIG. 3: A side view of tungsten rattle head for use in fishing comprises:
a) A tungsten body with a rattle chamber
b) A hook, attached to tungsten body
c) An optional wire bait holder used for attaching plastic fish attractors s such as worms and crawfish and other similar fishing accessories
d) an eyelet secured to the rearward end of said body for attaching a fishing line

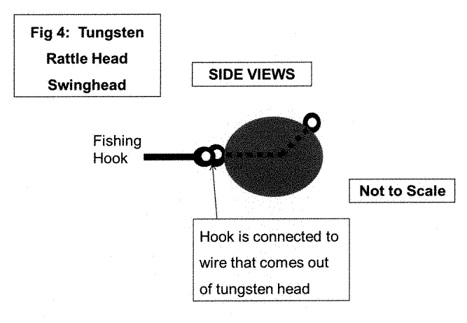

FIG. 4: A side view of tungsten rattle head for use in fishing comprises:
a) A tungsten body with a rattle chamber
b) A wire attached to tungsten body
c) A hook attached to the said wire
d) an eyelet secured to the rearward end of said body for attaching a fishing line

The embodiments of the invention in which an exclusive property or privilege is claimed are defined as follows:

1. A tungsten rattle head fishing lure comprising: a tungsten body, rattle elements, and a wire or hook

2. The tungsten rattle head fishing lure in claim 1 wherein said tungsten body is attached to the wire or hook to achieve the weight needed for sinking the lure

3. The tungsten rattle head fishing lure in claim 2 wherein the tungsten body has a hollow cavity where internal rattle elements are placed for the purpose of creating a click or rattle to attract fish during cast and retrieve
